(19) United States
(12) Patent Application Publication
(10) Pub. No.: US 2007/0050215 A1
(43) Pub. Date: Mar. 1, 2007

(54) System and method for assessing individual healthfulness and for providing health-enhancing behavioral advice and promoting adherence thereto

(75) Inventors: David H. Kil, Prospect, KY (US); Yan Zhang, Louisville, KY (US); Marlene Sigwalt Haydon, Louisville, KY (US); Bongjoo Shin, Prospect, KY (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(73) Assignee: Humana Inc.

(21) Appl. No.: 11/479,582

(22) Filed: Jun. 30, 2006

Related U.S. Application Data
(60) Provisional application No. 60/695,360, filed on Jun. 30, 2005.

(51) Int. Cl. G06F 19/00

(52) U.S. Cl. 705/3

(57) ABSTRACT

The present invention relates to a system and method for assessing individual healthfulness and for providing health-enhancing behavioral advice and promoting adherence thereto. More specifically, the invention relates to a system and method for eliciting one or more responses from an individual pertaining to the individual's health; for assessing, based on the responses, the individual's health; and for providing the individual advice concerning behavior to enhance the individual's health, and in which the advice is provided in a form and manner promoting adherence thereto.

This application claims the benefit of U.S. provisional patent application, Ser. No. 60/695,360, filed Jun. 30, 2005, for a system and method for assessing individual healthfulness and for providing health-enhancing behavorial advice and promoting adherence thereto, incorporated herein by reference.

### BACKGROUND OF THE INVENTION

(a) Field of the Invention

The present invention relates generally to a system and method for assessing individual healthfulness and for providing health-enhancing behavioral advice and promoting adherence thereto. More specifically, the invention relates to a system and method for eliciting one or more responses from an individual pertaining to the individual's health; for assessing, based on the responses, the individual's health; and for providing the individual advice concerning behavior to enhance the individual's health, and in which the advice is provided in a form and manner promoting adherence thereto.

(b) Description of the Prior Art

As known in the art, health risk assessments (HRAs) suffer from certain infirmities. Chief among them is the fact that the response rate is inversely proportional to the number of questions in an HRA form. Another problem is that use of too large an answer set can lead to less accurate prediction of outcomes (future medical claims costs, disease progression, the level of impact from clinical intervention) than use of a smaller answer set, provided the questions whose responses give rise to the smaller answer set are carefully chosen. Yet another difficulty is that very general health advice given to an individual participating in an HRA is typically not focused enough with respect to the individual's particular health status and psychosocial situation to ensure optimally healthful modification of the individual's behavior.

For example, one major work on the association between HRA and medical claims costs was conducted by Dr. Edington's group in the Health Management Research Center at the University of Michigan (UM-HNRC). See Louis Yen, Timothy McDonald, David Hirschland, Dee W. Edington. “Using Wellness Score from a Health Risk Appraisal to Predict Prospective Medical Claims Costs,” Journal of Occupational and Environmental Medicine, November 2003. In the Yen et al. study, the authors examined the association between medical claims cost and four factors, namely age, gender, disease status, and a wellness score from HRA. The wellness score was a composed score developed by UM-HNRC, and is generated from three major components: behavioral health risks, mortality risks, and preventive services usage. Behavioral health risks were weighted the most among the three components in the wellness score and preventive services weighted the least. The study sample included 19,861 employees from General Motors who participated in HRA at the beginning of the program. Their medical claims data was provided by preferred provider organizations. The authors adopted cross validation by dividing the whole samples into screening data and calibration data. Ninety-six groups were further formed from the screening data according to similar age, gender, disease status, and HRA scores. A multivariate regression model was consequently developed based on the groups other than individual members. The authors then tested the performance for each individual in both screening data and calibration data. The authors' model explained more than fifty percent of the variance at the group level. However, for individual-based data, the model only explained 5% of the variance on the actual cost and 10% of the variance on the log transformed cost. This is just slightly better than the simple age-gender model.

### SUMMARY OF THE INVENTION

The present invention relates generally to a system and method for assessing individual healthfulness and for providing health-enhancing behavioral advice and promoting adherence thereto. More specifically, the invention relates to a system and method for eliciting one or more responses from an individual pertaining to the individual's health; for assessing, based on the responses, the individual's health; and for providing the individual advice concerning behavior to enhance the individual's health, and in which the advice is provided in a form and manner promoting adherence thereto.

Predictive modeling (PM) is an important health care management tool for addressing escalating medical costs and inconsistency in care. From the large amount of medical, laboratory, and pharmacy data, PM identifies the relationship between current use pattern and future outcomes. This information is thereafter utilized for (1) identification and management of high-risk members through clinical intervention or preventive care comprising wellness programs, (2) underwriting renewal, and (3) budgeting. Meanwhile, HRA is applied in a variety of health promotion and disease prevention programs. It provides an efficient and inexpensive way to obtain the assessment of an individual's health risk.

For a new member with no health claims data, the best PM is the age-gender model, which provides R² of 2-3%. In this situation, a more powerful but user-friendly HRA would be a promising resource, where an HRA-based PM could complement the more accurate claims data-driven PM as it waits for claims data to accumulate over time.

In addition to establishing the quantitative relationship between HRA and health claims cost, there remains in the art an issue of minimizing consumer irritability by asking a minimum set of HRA questions. In today's consumer-centric market, it is imperative that one irritate the consumer as little as possible, and only ask a small number of absolutely necessary HRA questions. On the other hand, from a technical perspective, including too many irrelevant questions will not be helpful for PM and can even hurt the PM performance. Asking the minimum number of necessary HRA questions is important in enhancing consumer experience and PM performance.

There is therefore a need in the art for a health risk assessment that poses a set of questions small enough to elicit full responses yet whose answers are sufficient for accurate predictive modeling. A particularly pressing need is for a system and method for assessing individual healthfulness through use of a set of questions small enough to elicit full answers but informative enough to permit accurate predictions, and in which, in response to the answers, the individual is further provided with individually tailored health-promoting advice, and in which the individually tailored health-promoting information is provided in a form and a manner promoting adherence thereto.

More particularly, the present invention is a system for assessing individual healthfulness and for providing health-enhancing advice, comprising: at least one user computer which provides user access to a server system; the server system including a question database containing a plurality of health risk assessment questions, a feedback database containing content for each of a plurality of user groups, and a processor; where the server system communicates with a user using one of the user computers to access the server system; the server system presenting at least one of the health risk assessment questions to the user and then presenting additional questions to the user, the additional questions presented dependant on how the user answered previous questions; the server system placing the user into one of the plurality of user groups, the placement dependant upon how the user answered the questions presented; and where the server system provides health-enhancing feedback advice to the user, which advice is determined by the user group the user has been placed into.

The user access to the server system can facilitated by a wired or wireless communications link, with access over the internet, via a modem to modem connection, or other known means of communication. This access can be unsecure or, preferably, secure. For example, the user computer can be a regular personal computer, a laptop computer, a portable device such as an electronic handheld Blackberry® device, a remote terminal, or other known user computer device.

The plurality of health risk assessment questions are preferably divided into sets of questions which are hierarchically linked based on different user responses. The health risk assessment questions may include questions pertaining to a user's healthfulness, questions pertaining to a user's behavior, and questions pertaining to a user's lifestyle.

The health-enhancing feedback advice to the user includes information on at least one of future health status, likely disease progression, comparison of the user to a group of the user's peers, encouraging information, behavioral modification suggestions, and places where additional information can be found. It may also include a health risk assessment score calculated by the server system based on the user's answers to the questions presented, as well as a peer health risk assessment score to demonstrate to the user how that user's health risk assessment score compares to the user's peers' score. This user's health risk assessment score is preferably a weighted combination of a disease history score, a behavioral/lifestyle/family history score, and a clinical score. Further this health risk assessment score is calculated using a formula which is validated using claims data and computer simulations with derived prevalence rates.

The method for assessing individual healthfulness and for providing health-enhancing behavioral advice of the present invention, comprises the steps of:

a. having a user access a web site using a secure logon;

b. presenting to the user a question set having at least one question therein;

c. receiving the user's response to the question set;

d. dependant upon the user's response to the question set, repeating steps b and c until the user can be placed into one of a plurality of mutually exclusive user groups;

e. optionally presenting to the user additional question sets dependant on the user's user group placement;

f. receiving the user's response to any questions presented to the user in step e;

g. providing health-enhancing feedback advice to the user, which advice is determined by the user's user group and the user's responses in step f.

As with the system, in the method, each question set comprises at least one health risk assessment question, the question sets being hierarchically linked based on different user responses. The health risk assessment questions may include questions pertaining to a user's healthfulness, questions pertaining to a user's behavior, and questions pertaining to a user's lifestyle. As well, the health-enhancing feedback advice to the user can include information on at least one of future health status, likely disease progression, comparison of the user to a group of the user's peers, encouraging information, behavioral modification suggestions, and places where additional information can be found. Also, the health-enhancing feedback advice to the user can includes a health risk assessment score based on the user's answers to the questions presented and a peer health risk assessment score to compare how the user's health risk assessment score relates to the user's peer score. Preferably, the user's health risk assessment score is a weighted combination of a disease history score for the user, a behavioral/lifestyle/family history score for the user, and a clinical score for the user.

Even further, the method for assessing individual healthfulness and for providing health-enhancing behavioral advice of the present invention may comprise the steps of:

a. providing to an individual an initial set of one or more questions concerning the individual's healthfulness;

b. receiving the individual's response to the initial set of one or more questions;

c. partitioning the set of possible responses to the initial set of one or more questions into a multiplicity of mutually exclusive groups;

d. assigning the individual's response to the initial set of one or more questions to one of the multiplicity of mutually exclusive groups;

e. providing to the individual one or more second-tier health-related questions, the one or more second-tier questions tailored to the healthfulness of a typical member of the one of the multiplicity of mutually exclusive groups;

f. receiving the individual's response to the one or more second-tier questions;

g. partitioning the set of possible responses to the one or more second-tier questions into a further multiplicity of mutually exclusive groups;

h. assigning the individual's response to the one or more second-tier questions to one of the further multiplicity of mutually exclusive groups;

i. providing to the individual one or more behavior-related questions, the one or more behavior-related questions tailored to one or more health-related behavioral needs of a typical member of the one of the further multiplicity of mutually exclusive groups to which the individual's response to the one or more behavior-related questions has been assigned;

j. receiving the individual's response to the one or more behavior-related questions;

k. partitioning the set of possible responses to the one or more behavior-related questions into a final multiplicity of mutually exclusive groups;

l. assigning the individual's response to the one or more behavior-related questions to one of the final multiplicity of mutually exclusive groups; and,

m. and providing to the individual behavioral advice based on the final multiplicity of mutually exclusive groups containing the individual.

The behavioral advice provided to the individual is preferably tailored both to one or more health-related behavioral needs of a typical member of the one of the further multiplicity of mutually exclusive groups and also to one or more behavioral proclivities of a typical member of the one of the final multiplicity of mutually exclusive groups. Further, the behavioral advice provided to the individual comprises displaying in a display visible to the individual at least one descriptor of at least one aspect of the individual's healthfulness in comparison to the same at least one aspect of others' healthfulness, at least one plaudit concerning at least one salutary aspect of the individual's healthfulness, and at least one cue concerning at least one healthfulness-related behavior tailored both to at least one health-related behavioral need of a typical member of the one of the further multiplicity of mutually exclusive groups and also to at least one behavioral proclivity of a typical member of the one of the final multiplicity of mutually exclusive groups.

### BRIEF DESCRIPTION OF THE DRAWINGS

A better understanding of the present invention will be had upon reference to the following description in conjunction with the accompanying drawings.

FIG. 1 shows an overall system architecture according to the invention. The HRA server 6 can be part of the Web server 5 as long as the Web server 5 has its own local database and sufficient processing reserve to handle the extra load of administering HRA. Preferably, a nightly backup copies HRA data in the HRA database (DB) 7 to an enterprise data warehouse (EDW) 8 for further data analysis and incremental performance improvement. The HRA DB 7 stores an optimal set of HRA questions hierarchical organized based on a tree branching logic. Router 9 and Oracle database 10 are also shown.

FIG. 2 demonstrates tree branching logic with branching nodes 3 and terminal nodes 4. For example, if a person is diabetic and had an inpatient admission during the past 6 months, he can branch into a different node from those who are just diabetic. Associated with each terminal node 4 is a set of lifestyle recommendations and an HRA predictive model tailored to that terminal node 4 population.

FIG. 3 shows a conceptual view of an HRA-to-clinical logic mapping GUI.

FIG. 4 demonstrates the branching logic for clinical questions in Table 9 and should be viewed in concert with Tables 10-20.

FIGS. 5a-5b demonstrate how a display could be structured for providing to an individual tailored feedback in a fragmented frame display format comprising 2×3 health scores (peer/overall×clinical history/own disease history/behavioral+lifestyle+family history) and in which display are displayed health- and behavior-related visual elements, the elements including one or more tailored clinical condition center elements, one or more keep-it-up or good-for-you behavior elements, one or more you-can-improve behaviors for good health guide elements, and one or more fun & games elements.

FIG. 6 shows the score distribution from the simulation for the disease history score without age stratification for Score A for all populations.

FIG. 7 shows the score distribution from the simulation for the disease history score with age stratification for Score B for ages 0-20.

FIG. 8 shows the score distribution from the simulation for the disease history score with age stratification for Score B for ages 21-44.

FIG. 9 shows the score distribution from the simulation for the disease history score with age stratification for Score B for ages 45-64.

FIG. 10 shows the score distribution from the simulation for the disease history score with age stratification for Score B for ages 65 and over.

FIG. 11 shows the score distribution from the simulation for the behavior/lifestyle/family history score without age stratification for the whole population.

FIG. 12 shows the score distribution from the simulation for the clinical score without age stratification for Score A for ages all populations.

FIG. 13 shows the score distribution from the simulation for the clinical score with age stratification for Score B for ages 0-20.

FIG. 14 shows the score distribution from the simulation for the clinical score with age stratification for Score B for ages 21-44.

FIG. 15 shows the score distribution from the simulation for the clinical score with age stratification for Score B for ages 45-64.

FIG. 16 shows the score distribution from the simulation for the clinical score with age stratification for Score B for ages 65 and older. For FIGS. 13-16, many of the members barely use healthcare resources. It is noted that for FIGS. 14-16, there are fewer members in the gap 2, which we would expect to mean that, if a member did use healthcare resources, the costs would increase.

FIG. 17 shows the overall score distribution without age stratification for Score A.

FIG. 18 shows the overall score distribution with age stratification for Score B for ages 0-20.

FIG. 19 shows the overall score distribution with age stratification for Score B for ages 21-44.

FIG. 20 shows the overall score distribution with age stratification for Score B for ages 45-64.

FIG. 21 shows the overall score distribution with age stratification for Score B for ages 65 and over.

### DETAILED DESCRIPTION OF THE PREFERRED EMBODIMENT

—The following acronyms are used in this application: CCS: Clinical (Chronic) Condition Score; CIA: Clinical Intervention Appropriateness; CPT: Current Procedure Terminology; DB: Database; EDW: Enterprise Data Warehouse; GUI: Graphical User Interface; HRA: Health Risk Assessment; ICD-9: International Classification of Diseases; KCCM: Knowledge Creation and Content Management; MCC: Major Clinical Condition; PM: Predictive Model; PMPM: Per member per month; POT: Place of Treatment; U-Health: Ubiquitous Health; WBS: Work Breakdown Structure; YDR: Yourdiseaserisk

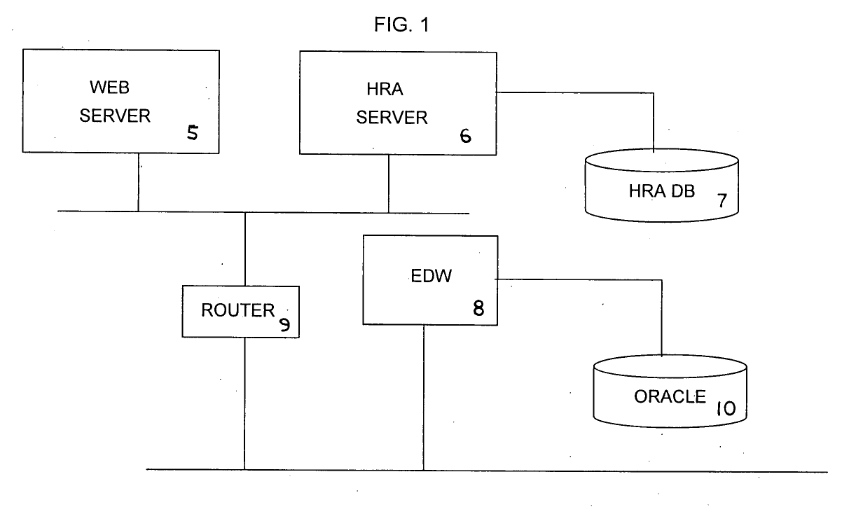

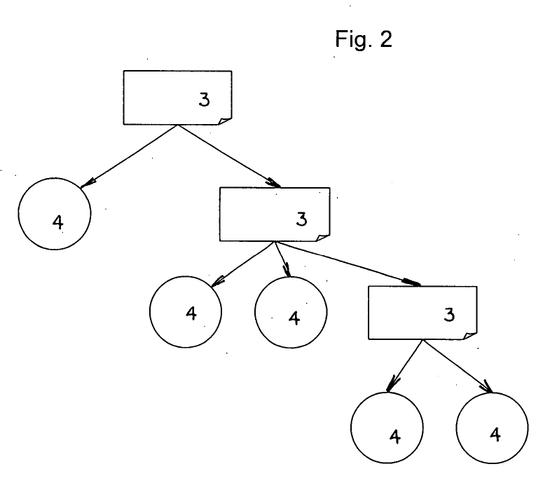

A system according to the invention, in an embodiment, is depicted in FIG. 1. Use of a system and method according to the invention proceeds, for example, as follows. An individual user (herein referred to as either “individual” or “user”) of the system and method logs into a Web site using a secure logon. Typically, a user accesses a system according to the invention through use of a graphical display means, such as a screen known in the art for display of a graphical user interface such as a graphical user interface according to the invention, by means of which are displayed by the system to the user one or more prompts for responses, such responses being transmitted into the system through the user's use of a response-indicating means, such as a keyboard or a mouse, and by means of which graphical display means are displayed by the system to the user one or more recommendations concerning the user's future health-related behavior.

In a preferred embodiment, the one or more prompts for responses comprise a set of one or more initial questions pertaining to the user's healthfulness. Subsequent to transmission by the user of the user's response to the one or more initial questions, a set of one or more second-tier questions is displayed by the system to the user, preferably through the graphical display means. The content of the one or more second-tier questions depends on the content of the user's response to the one or more initial questions. The cycle of user response and system display of further questions whose content depends on the content of all preceding responses by the user is repeated iteratively until the user is assigned to a terminal group or “bucket” of population. Once the user is assigned to such a bucket, the system prompts the user to respond to one or more questions concerning the user's behavior and lifestyle. Subsequent to the user's transmission of the user's response to the one or more questions concerning the user's lifestyle, the system displays a tailored feedback message, the content of which tailored feedback message depends on the content of all preceding responses by the user. In a particularly preferred embodiment, the content of the tailored feedback message comprises content selected not merely to inform the user of behavioral choices but additionally designed to encourage the user to adhere to healthful behavioral choices.

In an especially preferred embodiment, the assignment of the user to a bucket is determined according to a hierarchical tree logic, the hierarchical tree logic based on the partitioning of a previously studied population into clusters.

Additional detail for embodiments of the invention is provided below.

—Operational Scenario:

During open enrollment, a new member “Jim” logs into the Humana (Humana Inc. of Louisville, Ky.) web site using our secure logon. Jim follows the Web wizard to select the most appropriate health benefit plan for him and his family. After he finishes his benefit plan selection, he is greeted with an HRA welcome screen.

1. Jim answers three initial questions.

2. The HRA hierarchical tree logic prepares the next set of questions depending on how he responded the first three questions. This process may be continued for one to three more times depending on the hierarchical tree depth.

3. After Jim finishes answering all the questions that have been validated with claims data, if that information is available for Jim, the HRA predictive model assesses his future health status and current healthcare needs. It then asks a short list of behavioral and lifestyle questions highly relevant to his current situation and future needs. Over time, these lifestyle and behavioral questions will also be validated with real claims data and embedded into the HRA hierarchical tree logic to improve the PM accuracy further.

4. The HRA PM prepares a tailored feedback message, preferably consisting of the following:
a. Future health status and likely disease progression.
b. Comparison of Jim with Jim's peers to fire his competitive spirit.
c. Encouragement.
d. Areas that can be improved through behavioral modification.
e. Useful Web links.

5. With Jim's permission, the feedback messages can be emailed to his registered or specified email address.

—Our Technical Approach

1. Collect a pool of available HRA questions from multiple sources. Add our own HRA questions based on top features from our claims-based PM. Put everything in a relational database table with a schema derived from the HRA-to-clinical logic mapping toolbox.

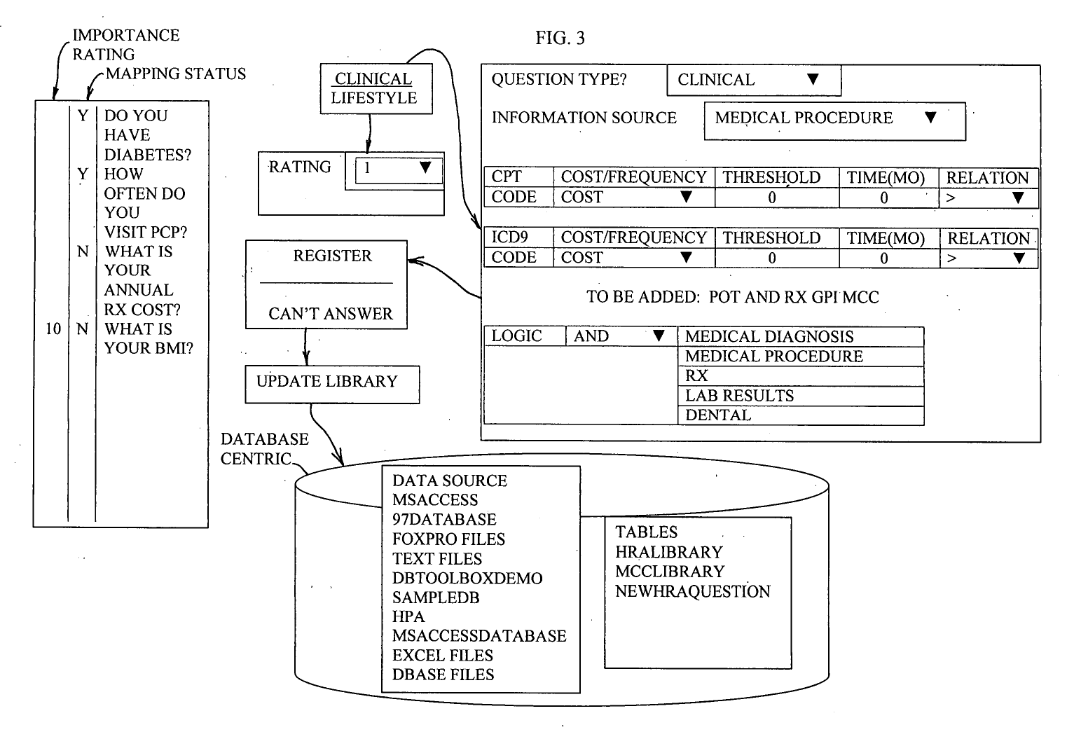

2. Design a GUI toolbox that a clinician can use to map HRA questions to clinical logic so that features can be extracted automatically. FIG. 3 shows a mapping GUI layout.
a. UI controls must be organized sequentially with only the relevant ones shown as a function of temporal logical sequence.
b. Hierarchical tree clustering logic.
c. Lifestyle questions that can't be validated with claims data: Assign an importance rating. Multiple scores can be averaged to rank the lifestyle questions in the HRA database for final HRA subset selection.
d. Current clinical logic.
   i. Medical MCC (ICD-9 1 through 9 with 2-9 rolled into secondary MCC).
   ii. Medical Place-of-Treatment (POT) codes.
   iii. Pharmacy MCC.
e. Future clinical logic
   i. CPT-4: Medical procedural codes.
   ii. M&R: 60+categorizations of medical claims based on ICD-9 diagnosis and CPT-4 procedural codes.
   iii. More detailed ICD-9 diagnosis and procedure codes.
   iv. Laboratory data.

3. Extract HRA features for every individual in EDW claims database. Attach predictive or dependent variables to HRA features, thus creating a giant 2-dimensional matrix.

4. Select top 4 features and create a hierarchical tree network. With hierarchical binary partitioning, for example, we have a total of 16 population clusters.

5. For each population cluster, perform separate feature optimization and learning algorithm selection. Associated with each population cluster will be an optimal subset of validated HRA questions and top 10 lifestyle questions to be validated one year after the HRA administration.
a. Performance sensitivity analysis to account for wrong or misleading responses to HRA questions.
b. Feature robustness to fine tune the final optimal feature subset.
c. Final performance statistics as a function of optimal feature subset and the degree of perturbation (i.e., intentionally adding noise to perfect HRA responses).

6. Working with a clinical team, design a feedback database for each population cluster as a function of dominant clinical conditions (person centric, not disease centric) and overall risk assessment.

7. Implement a Web-based HRA with database interface. Provide feedback tailored to each member based on his or her population cluster, clinical conditions, and risk assessment.

8. Periodically reiterate steps 1-7 with lifestyle/behavioral questions included for a truly comprehensive HRA optimized for each targeted population.

—Relationship to Dialog Development

Kate Lorig (K. Lorig et al., Living a Healthy Life with Chronic Conditions. Bull Publishing, Boulder, Colo., 2000) makes it clear that the most important skill of a person with chronic illness is learning how to cope with illness, live daily lives as normally as possible, and deal with emotion. The role of dialog, or feedback, is as follows:

1. Education: Help the consumer understand symptoms, likely disease progression, and benefits associated with various intervention options (behavioral and clinical) available. The more specific and timely, the more effective.

2. Goal setting and guidance: Teach the consumer how to navigate through complex options, how to set realistic goals with tangible benefits, and how to stick to them through various tracking mechanisms. For example, the Yahoo Health portal has an interesting series of survey questions.

3. Progress tracking and feedback: Use both predictive models and trend analyses to communicate cause-effect linkages to the consumer so that she can start to appreciate the role of lifestyle changes in improving physical appearance, fitness, and overall quality of life.

4. Emotional support: Through positive reinforcement and emotionally responsible (truth mixed with humor and encouragement) dissemination of scientific evaluation of progress, the dialog system can provide a primitive form of emotional support.

With this in mind, a dialog database schema is constructed that consists of (1) current and future variables that help us understand current clinical/psychological states of the consumer and likely future disease trajectories; (2) readymade dialog templates associated with education, goal setting/tracking, progress tracking/feedback, and humor/emotional support that can break through boredom and tediousness; and, (3) provision for continuous model learning that allows us to improve the dialog engine performance over time.

Each consumer is characterized in terms of disease profile (disease cluster in joint or individual disease in marginal operating space so that we can avoid the curse of dimensionality at the expense of suboptimal performance) and psychosocial behavioral cluster. The exercise node (inferred and self-reported) is similarly partitioned into a manageable number of subspaces. The nutrition node (self-reported) can be divided into a two-dimensional grid of calories (portion) and the type of diet, such as complex carbohydrate diet, Atkins/south beach diet, and balanced meal diet. The vital-signs node (hard) can be divided into separate clusters based on trend analysis while the PM node (hard) can provide insights into likely future states in terms of health status and utilization (clinical condition score and PMPM dollars). Finally, using the available secondary research literature and our own Insight engine tightly integrated with the dynamic impact analysis module, we can fill in the blanks of the outcomes node (hard) so that we can start the process of deriving utility functions associated with the five nodes (consumer, exercise, vital signs, nutrition, and PM) above the outcomes node given action, i.e., dialog.

The utility functions will be sparsely populated with coarse partitioning in the five-node space initially. However, through the marriage of qualitative research and quantitative knowledge discovery, we can fill in the space prior to and during our pilot study with continuous feedback.

—HRA Score

Realage.com uses real age as a proxy for a member's current health status while yourdiseaserisk.com provides a color-coded severity score.. While these scores are intuitive, some feel that real age is a bit arbitrary and that yourdiseaserisk (YDR) score is not comprehensive. That is, depending on the number of chronic conditions one has, she may have to take multiple YDR HRA's and interpret multiple scores. Nevertheless, we feel that realage.com's HRA score is a tad more consumer friendly albeit at the expense of much greater consumer burden.

Our proposed score is based on a two-dimensional vector space of predicted CCS and predicted severity score. CCS is a member's expected chronic disease burden while severity score is the projected future cost. In general, the correlation coefficient between the two is approximately 0.35. The CCS and severity score pair can be transformed into the log space with minor tweaking so that we can deal with a multivariate Gaussian probability density function with p of 0.35. Instead of a perfectly round mountain, we must visualize a slightly tilted mountain, where the major axis is greater than the minor axis. A simple CCS-versus-PMPM plot with the PMPM values on the x-axis with low cost at the left and high cost at the right and with the CCS values on the y-axis with healthy at the bottom and sick at the top demonstrates this slightly tilted mountain. For example, for the upper right quadrant of unhealthy who spend a lot of money we find 17.27% of the population or 310,646. For the upper left quadrant of unhealthy who do not spend too much money we find 13-33% of the population or 239,756. For the lower right quadrant of healthy who spend too much money we find 10.37% of the population or 186,581. For the lower left quadrant or healthy who do not spend too much money we find 59.02% of the population or 1,061,616.

Next the entire two-dimensional vector space is divided into cells of approximately equal population. Associated with each cell is a composite HRA score, which can be as simple as the sum of CCS and severity score. Furthermore, the same CCS-versus-PMPM maps can be constructed for multiple disease clusters so that we can provide the average HRA score for each disease cluster that a member belongs to so that his competitive spirit can be fired in order to improve his health through behavioral modification.

In summary, we envision two HRA scores—normalized based on the age-gender bucket and the disease-cluster bucket. The scale may be similar to IQ in that 100 means average, with each 10 point representing one standard deviation.

### Example Survey Questions

Please respond in 1-10 scale with 10 being the most desirable state (agree most definitely, extremely satisfied, for example)

1. How satisfied are you with your current health?

2. Do you know what you need to do in order to improve your health?

3. How important. do you think the following health improvement steps are for you to improve your health?
a. Proper diet.
b. Regular exercise.
c. Stress reduction.
d. Relationship building or repairing.
e. Laughing a lot.

4. What rating would you give yourself for adhering to health improvement plans?

5. What are the impediments to adhering to health improvement plans (1-10 scale with 10 being definitely yes)?
a. Job stress.
b. Family/relationship stress.
c. Too busy.
d. Health improvement plans are generally too boring.
e. I'm indestructible.

6. If I know that the maintenance of your current lifestyle can lead to deteriorating health with unpleasant health outcomes (loss of vision in 3 years and possible foot amputation), how should I break the news to you with the ultimate goal of helping you help yourself?
a. If you don't do this and that, you will drop dead in a few years. At best, you will live a miserable life.
b. Please think of your children and your desire to see them get married and live happily. One way to achieve that goal is for you to do the following:
   i. Walk at least 3000 steps a day.
   ii. (additional actions) . . .
c. Wouldn't it be fun for you to make friends at local YMCA while working out? According to Reese Witherspoon, workout increases the level of dopamine in your brain, which in turn makes you happy.
d. These specific recommendations are scientifically proven.

7. If none of them works for you, what would be the best way to motivate yourself so that you can live healthier, happier life?

8. How likely is your receptivity to an intelligent device that can measure your vital signs and caloric expenditure, offer timely advice on how to improve your health and quality of life, and give you reward points for healthy behaviors that you can redeem at participating stores? How crucial is each component for you?
a. Unobtrusive measurement of vital signs and caloric expenditure.
b. Timely advice that's fin to consume, easy to follow, and flexible enough to allow reentry.
c. Reward system.

9. How likely are you willing to pay for such a device that can be configured to your exact specification?
a. $500 per device with free lifetime advice.
b. $100 per device with $20 per month subscription fee for advice.
c. $30 per month subscription fee for advice.
d. Insurance company must pay for this in exchange for data sharing on a deidentified basis.

10. How likely are you willing to participate in a pilot study where you must share your vital signs data with an insurance company on a deidentified basis such that we can develop a solution to help people like you who suffer from chronic conditions?

—Details on HRA scores. HRA scores are composite scores with three combined components. For example, the disease history score can be weighted at 35%, the behavorial/lifestyle/family history score can be weighted at 20%, and the clinical score can be weighted at 45%. Preferably, two HRA scores are presented for each user. One is the overall wellness score, which is denoted as Score A. Another score is the score related to peers, called Score B, which is currently stratified by age. Each score is the composition of these three combined components. All scores are normalized to [0 10]. 10 indicates the best health status, and 0 is the worst. Optionally, a 0-100 normalized score can be used, again with 100 indicating the best health score and 0 the worst.

—Procedures for calculating Scores A and B and Tables:

I. Calculate Disease History score S1A for Score A or S1B for Score B.
1. Sum all scoring functions in Table 1; denote the result as x1.
2. Truncate. If x1>BD, x1=BD.
3. S1=C1*x1+C2; for S1A, use coefficients (C1, C2, BD) in Table 2; for S1B, use those in Table 3.

II. Calculate Behavior/Lifestyle/Family history score S2 (S2 is NOT age stratified).
1. Sum all scoring functions in Table 4; denote the result as x2.
2. Count the number n of satisfied risk factors listed in Table 5. If n is greater than 1, use the following formula to get the additional score x_inter, then add it to x2.
   x_{—}inter=(1.5ˆ(n−1)−1)*0.1
   x2=x2+x_{—}inter
3. Truncate. If x2>BD, x2=BD.
4. S2=C1*x2+C2; C1, C2, and BD are obtained from Table 6.

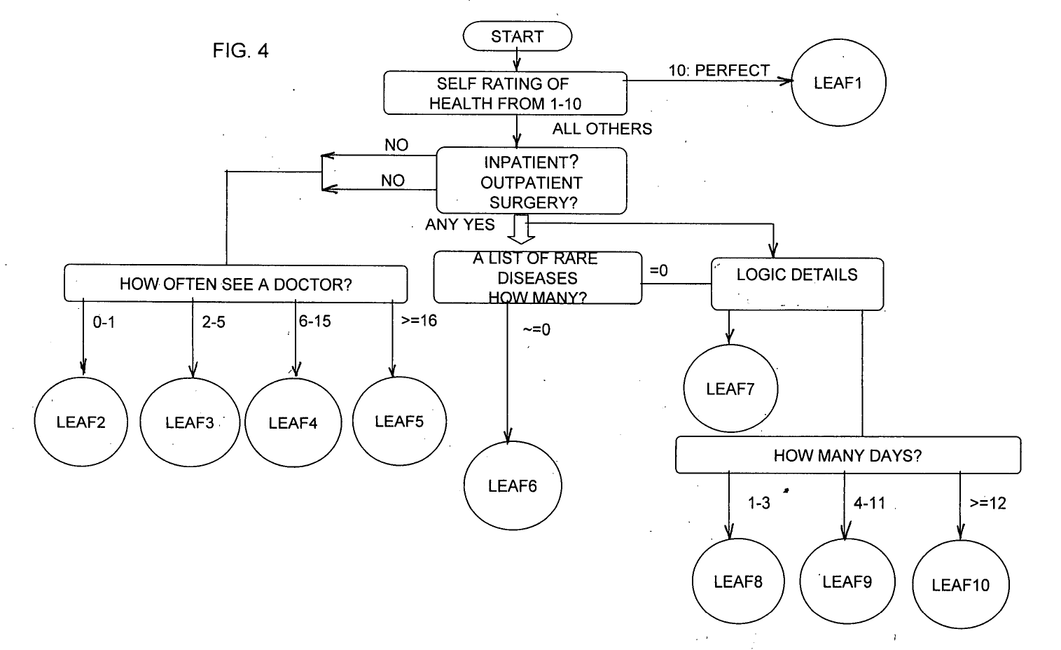

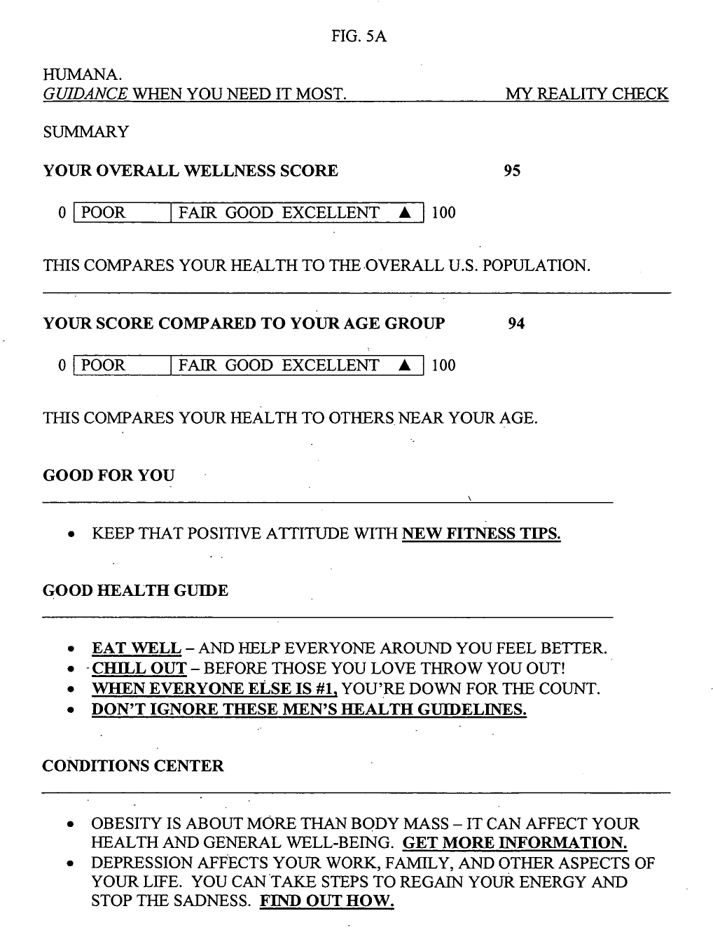

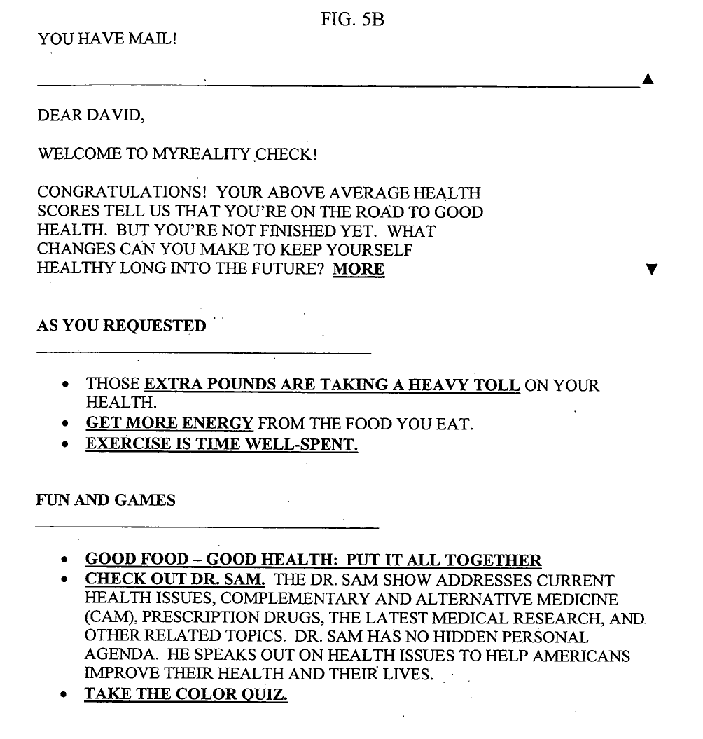

III. Calculate Clinical score S3A for Score A or S3B for Score B.
1. According to the sketch of branching logic for clinical questions in FIG. 4 and the questions in Tables 9-20, compute the model prediction y. Left truncate y with threshold=3.5999 (mean cost of the most healthy people): y(y<threshold)=threshold.
2. Find the appropriate age stratification, compute the score and right truncate if applicable.
   y1=5+(y−Mean)/Std
   y1(y1>10)=10
3. S3=C1*y1+C2; for S3A, use coefficients (C1, C2, Mean, Std) in Table 7; for S3B, use those in Table 8.

IV. Calculate the overall scores—Score A and Score B, and provide the guidance as in Table 21.
Score A=0.35×S1A+0.2×S2+0.45×S3A
Score B=0.35×S1B+0.2×S2+0.45×S3B

—Tables.

Component 1: Disease History Score (Tables 1-3)

TABLE 1
Questions and scores for Disease History.

| ID | Disease | Scoring Function |
|---|---|---|
| HQ1 | Pregnancy/maternal | $x = \{ \begin{matrix}0 & No \\ 0.1 & Yes\end{matrix}$ |
| HQ2 | Diabetes | $x = \{ \begin{matrix}0 & No \\ 0.3 & Yes\end{matrix}$ |
| HQ3 | Heart disease CAD = coronary artery disease CHF—Congestive Heart Failure | $x = \{ \begin{matrix}0 & No \\ 0.3 & Yes\end{matrix}$ |
| HQ4 | Cancer | $x = \{ \begin{matrix}0 & No \\ 0.4 & Yes\end{matrix}$ |
| HQ5 | Back pain | $x = \{ \begin{matrix}0 & No \\ 0.1 & Yes\end{matrix}$ |
| HQ6 | Arthritis | $x = \{ \begin{matrix}0 & No \\ 0.1 & Yes\end{matrix}$ |
| HQ7 | Rare disease | $x = \{ \begin{matrix}0 & No \\ 0.4 & Yes\end{matrix}$ |
| HQ8 | Osteoporosis | $x = \{ \begin{matrix}0 & No \\ 0.1 & Yes\end{matrix}$ |
| HQ9 | Stroke | $x = \{ \begin{matrix}0 & No \\ 0.3 & Yes\end{matrix}$ |
| HQ10 | High Cholesterol | $x = \{ \begin{matrix}0 & No \\ 0.1 & Yes\end{matrix}$ |
| HQ11 | Obesity | Null |
| HQ12 | HBP | $x = \{ \begin{matrix}0 & No \\ 0.2 & Yes\end{matrix}$ |
| HQ13 | Alzheimers | $x = \{ \begin{matrix}0 & No \\ 0.5 & Yes\end{matrix}$ |
| HQ14 | Asthma | $x = \{ \begin{matrix}0 & No \\ 0.2 & Yes\end{matrix}$ |
| HQ15 | Kidney (CKD—Chronic Kidney Disease) | $x = \{ \begin{matrix}0 & No \\ 0.4 & Yes\end{matrix}$ |
| HQ16 | Depression | $x = \{ \begin{matrix}0 & No \\ 0.1 & Yes\end{matrix}$ |
| HQ18 | Chronic Liver disease | $x = \{ \begin{matrix}0 & No \\ 0.4 & Yes\end{matrix}$ |
| HQ19 | Frequent indigestion | $x = \{ \begin{matrix}0 & No \\ 0.1 & Yes\end{matrix}$ |

TABLE 2
Coefficients for computing Disease History score without age
stratification.

| Age Group | C1 | C2 | BD |
|---|---|---|---|
| All age | −8.3333 | 10 | 1.2 |

TABLE 3
Coefficients for computing Disease History score with age stratification.

| Age Group | C1 | C2 | BD |
|---|---|---|---|
| 0-20 | −12.5 | 10 | 0.8 |
| 21-44 | −10 | 10 | 1 |
| 45-64 | −7.1429 | 10 | 1.4 |
| >=65 | −5.8824 | 10 | 1.7 |

Component 2: Behavior/Lifestyle/Family History Score (Tables 4-6)

TABLE 4
Questions and scores for Behavior/Lifestyle/Family history.

| ID | Category | Question | Function |
|---|---|---|---|
| BQ1 | Behavioral | Smoking - How many per day (0->20 cigarettes) | $\begin{matrix}x ( n ) = \{ \begin{matrix}0 & n = 0 \\ 0.3 & n > 20 \\ 0.013323 \times ( 1.1487 ⋀ n ) + 0.086683 & 0 < n \leq 20\end{matrix} \\ If n < 1 , let n = 1 / 2 when calculating x ( n ) .\end{matrix}$ |
| BQ2 | Behavioral | Smoking (Cigars) - How many per day (0->5 cigars) | $\begin{matrix}x ( n ) = \{ \begin{matrix}0 & n = 0 \\ 0.1 & n > 5 \\ 0.002333 \times ( 2.0001 ⋀ n ) + 0.025334 & 0 < n \leq 5\end{matrix} \\ If n < 1 , let n = 1 / 2 when calculating x ( n ) .\end{matrix}$ |
| BQ14 | Behavioral | Smoking - Do you use smokeless tobacco? | $x = \{ \begin{matrix}0 & No \\ 0.1 & Yes\end{matrix}$ |
| BQ3 | Behavioral | Smoking - How long (0->20 years) | $\begin{matrix}x ( n ) = \{ \begin{matrix}0 & n = 0 \\ 0.3 & n > 20 \\ 0.013323 \times ( 1.1487 ⋀ n ) + 0.086683 & 0 < n \leq 20\end{matrix} \\ If n < 1 , let n = 1 / 2 when calculating x ( n ) .\end{matrix}$ |
| BQ4 | Behavioral | Alcohol | $x ( n ) = \{ \begin{matrix}0.1 & n > 2 for Man n > 1 forWoman \\ 0 & otherwise\end{matrix}$ |
| BQ5 | Behavioral | How many times have you lost and regained over 10 pounds yo-yo dieting) 0-≧5 | $x ( n ) = \{ \begin{matrix}0 & n = 0 \\ 0.3 & n > 5 \\ 0.05 \times n + 0.05 & 0 < n \leq 5\end{matrix}$ |
| BQ7 | Nutrition | Fruits | $x ( n ) = \{ \begin{matrix}0 & n \geq 2 \\ 0.1 & otherwise\end{matrix}$ |
| BQ6 | Nutrition | Vegetable | $x ( n ) = \{ \begin{matrix}0 & n \geq 3 \\ 0.1 & otherwise\end{matrix}$ |
| BQ8 | Nutrition | High Fat how many servings of foods that are high in fat (0-10 and more) | $x = \{ \begin{matrix}0 & n \leq 4 \\ 0.1 & n > 4\end{matrix}$ |
| BQ9 | Nutrition | High Sugar (I eat high sugar food four times a week) | $x = \{ \begin{matrix}0 & No \\ 0.1 & Yes\end{matrix}$ |
| BQ10 | Nutrition | High salt processed foods | $x = \{ \begin{matrix}0 & No \\ 0.1 & Yes\end{matrix}$ |
| BQ11 | Nutrition | High fiber | $x = \{ \begin{matrix}0.1 & No \\ 0 & Yes\end{matrix}$ |
| BQ17 | Fitness | How many hours/wk do you exercise (0-7) | $x ( n ) = \{ \begin{matrix}0.5 & n = 0 \\ 0 & n > 7 \\ 0.63179 \times ( 0.48077 ⋀ n ) - 0.0037551 & 0 < n \leq 7\end{matrix}$ |
| FHQ3 | Family History | CAD | $x = \{ \begin{matrix}0 & No \\ 0.2 & Yes\end{matrix}$ |
| FHQ12 | Family History | High blood pressure | $x = \{ \begin{matrix}0 & No \\ 0.2 & Yes\end{matrix}$ |
| FHQ4 | Family History | Cancer | $x = \{ \begin{matrix}0 & No \\ 0.2 & Yes\end{matrix}$ |
| FHQ2 | Family History | Diabetes | $x = \{ \begin{matrix}0 & No \\ 0.2 & Yes\end{matrix}$ |
| FHQ10 | Family History | High Cholesterol | $x = \{ \begin{matrix}0 & No \\ 0.2 & Yes\end{matrix}$ |
| FHQ9 | Family History | Stroke | $x = \{ \begin{matrix}0 & No \\ 0.2 & Yes\end{matrix}$ |
| FHQ11 | Family History | Obesity | $x = \{ \begin{matrix}0 & No \\ 0.1 & Yes\end{matrix}$ |
| FHQ7 | Family History | Rare Diseases | $x = \{ \begin{matrix}0 & No \\ 0.1 & Yes\end{matrix}$ |
| RQ3 | Readiness to Change | Interest in smoking cease (Only if applicable) | $x = \{ \begin{matrix}0 & No \\ - 0.1 & Yes\end{matrix}$ |
| RQ4 | Readiness to Change | Interest in nutrition | $x = \{ \begin{matrix}0 & No \\ - 0.1 & Yes\end{matrix}$ |
| RQ5 | Readiness to Change | Interest in weight - if not (link to obesity) | $x = \{ \begin{matrix}0 & No \\ - 0.1 & Yes\end{matrix}$ |
| RQ6 | Readiness to Change | Cardio/fitness interest | $x = \{ \begin{matrix}0 & No \\ - 0.1 & Yes\end{matrix}$ |
| RQ9 | Readiness to Change | (Conviction) I can accomplish anything I want - scale from 1 to 10 with 10 being the highest | $x = \{ \begin{matrix}0.1 & n \leq 5 \\ 0 & n > 5\end{matrix}$ |
| RQ10 | Readiness to Change | I am motivated to do anything . . . - scale from 1 to 10 with 10 being the highest | $x = \{ \begin{matrix}0.1 & n \leq 5 \\ 0 & n > 5\end{matrix}$ |
| CQ1 | Health Rating | 1-10 - depends on range | $x ( n ) = \{ \begin{matrix}1 & n < 5 \\ - 0.2 \times n + 2 & 5 \leq n \leq 10\end{matrix}$ |
| QQ9 | Stress | Family stress (From 1 to 10, 10 is the worst) | $x = \{ \begin{matrix}0 & \leq 3 \\ 0.1 & > 3\end{matrix}$ |
| QQ16 | Stress | Hours do you work a week - high hours higher wt. | $x ( n ) = \{ \begin{matrix}0 & n \leq 40 \\ 0.1 & 40 < n \leq 60 \\ 0.2 & n > 60\end{matrix}$ |
| QQ8 | Stress | Job stress (From 1 to 10, 10 is the worst) | $x = \{ \begin{matrix}0 & \leq 5 \\ 0.1 & > 5\end{matrix}$ |
| QQ17 | Stress | Vacation (How many months since last vacation) | $x = \{ \begin{matrix}0 & \leq 12 \\ 0.1 & > 12\end{matrix}$ |
| QQ12 | Stress | Spouse's health | $x = \{ \begin{matrix}0 & Good \\ 0.1 & Notgood\end{matrix}$ |
| BQ15 | Stress | How do you deal with anger: Eat, Aggression, Sleep, | $x = \{ \begin{matrix}0 & Good \\ 0.1 & Notgood\end{matrix}$ |
| | | | Eat and Aggression are not good. |
| | | Complain, Work out, | |
| | | Vacation, None | |
| | | of the above | |
| QQ15 | Stress | Friends (I have a close circle of friend/s that I can . . . ) | $x = \{ \begin{matrix}0.1 & No \\ 0 & Yes\end{matrix}$ |
| DQ12.1 | Risk Factors | Wt/Ht to cal | t = (weight in lbs * 0.4536)/(height in inches * |
| | | BMI* | 0.0254)\hat{ }2 |
| DQ11/ DQ12 | | | $x ( t ) = \{ \begin{matrix}0.1 & 25 \leq t < 30 \\ 0.2 & t \geq 30 \\ 0 & otherwise\end{matrix}$ |
| DQ13 | Risk Factors | Waist | $x ( t ) = \{ \begin{matrix}0.1 & 37.1 \leq t < 40 men & 31 \leq t < 35 women \\ 0.2 & t \geq 40 men & t \geq 35 women \\ 0 & otherwise & \end{matrix}$ |
| HQ17 | Risk Factors | Prematurity | $x = \{ \begin{matrix}0 & No \\ 0.1 & Yes\end{matrix}$ |

TABLE 5
Interaction of risk factors.

| ID | Question | Number of Risk factors | |
|---|---|---|---|
| DQ12.1 | Obesity (BMI >= 25) | 1 | |
| FHQ2 | Family history of diabetes | 1 | Bound by 2 |
| FHQ3 | Family history of CAD | 1 | |
| FHQ12 | Family history of HBP | 1 | |
| FHQ10 | Family history of High cholesterol | 1 | |

| | | |
|---|---|---|
| HQ12 | HBP | 1 |
| HQ10 | High cholesterol | 1 |
| BQ1 | Smoking | 1 |

TABLE 6
Coefficients for computing Life Style/Behavior/Family history score.

| Age Group | C1 | C2 | BD |
|---|---|---|---|
| All age | −2.8923 | 10.362 | 3.5825 |

Component 3: Clinical Score (Tables 7-8)

TABLE 7
Coefficients for computing Clinical Score without age stratification.

| Age Group | Mean | Standard deviation | C1 | C2 |
|---|---|---|---|---|
| All Age | 8.4122 | 5.565 | −1.7051 | 17.051 |

TABLE 8
Coefficients for computing Clinical Score with age stratification.

| | | Standard | | |
|---|---|---|---|---|
| Age Group | Mean | deviation | C1 | C2 |
| 0-20 | 5.7616 | 3.2517 | −1.7652 | 17.652 |
| 21-44 | 8.0695 | 4.8748 | −1.69 | 16.9 |
| 45-64 | 11.402 | 6.4147 | −1.6283 | 16.283 |
| >=65 | 14.379 | 7.692 | −1.5776 | 15.776 |

TABLE 9
Master list of clinical questions

| Question | |
|---|---|
| ID | Question Text |
| CQ1 | Please rate your health from 1-10, where 10 is Perfect and 1 is not well at all. |
| CQ2 | Have you been admitted to a hospital or other inpatient facility (e.g., skilled |
| | nursing facility, physical rehabilitation facility, nursing home)? Yes/No |
| CQ3 | Have you had out-patient surgery? Yes/No |
| CQ4 | How often did you see your doctor? (a) 0-1 (b) 2-5 (c) 6-15 (d) >=16 |
| CQ5 | Do you have any of the following uncommon diseases (Please check all that apply) - |
| | How many? (a) =0 (b) ˜=0 |
| CQ6 | How many days did you spend in the hospital or other inpatient facility (see above |
| | explanation)? (a) 0 (b) 1-3 (c) 4-11 (d) >=12 |
| CQ7 | How many medications did you take for longer than 6 months? (a) =0 (b) 1-6 |
| | (c) 7-11 (d) >=12 |
| CQ8 | How many medications did you take? (a) <=3 (b) 4-8 (c) 9-15 (d) >=16 |
| CQ9 | How many months did you not receive any medical treatment? (a) <=3 (b) 4-7 |
| | (c) 8-10 (d) >=11 |
| CQ10 | Age (derived from DQ2) |
| CQ11 | How many medications did you take longer than 3 months? (a) =0 (b) 1-2 (c) |
| | 3-9 (d) >=10 |
| CQ12 | Are you currently pregnant? Yes No |
| CQ13 | How many times did you receive care at any of the following: freestanding medical |
| | facility, outpatient hospital facility, or “other” healthcare provider: (excludes |
| | physician office visits, hospital emergency room and outpatient surgery). |
| | Examples: Freestanding Radiology (x-rays), Freestanding laboratory, dialysis |
| | clinic, physical therapy. Other healthcare provider examples: Chiropractor, |
| | acupuncturist, massage therapist, home health, hospice, durable medical equipment |
| | such as wheelchair, oxygen (a) =0 (b) 1 (c) 2-11 (d) >=12 |
| CQ14 | How many months in the past year did you receive care at any of the following: |
| | freestanding medical facility, outpatient hospital facility, or “other” healthcare |
| | provider: (excludes physician office visits, hospital emergency room and outpatient |
| | surgery). Examples: Freestanding Radiology (x-rays), Freestanding laboratory, |
| | dialysis clinic, physical therapy. Other healthcare provider examples: |
| | Chiropractor, acupuncturist, massage therapist, home health, hospice, durable |
| | medical equipment such as wheelchair, oxygen (a) =0 (b) 1 (c) 2-6 (d) >=7 |
| CQ15 | When was the last time you received any medical care? (a) currently (b) 1 mon. |
| | ago (c) 2-10 mon. ago (d) 11-12 mon. ago Yan - does this include physician??? |
| CQ16 | Have you been diagnosed or treated for cancer in the past 12 months? |
| | Yes No |
| CQ17 | Did you experience recurring back, neck or joint pain? Yes No |
| CQ18 | How many months did you visit your doctor more than 3 times? (a) =0 (b) 1 |
| | (c) 2-3 (d) >=4 |
| CQ19 | How many times were you admitted to the hospital (inpatient stay)? (a) =0 (b) 1 |
| | (c) 2-4 (d) >=5 |
| CQ20 | Do you have End Stage renal disease (ESRD) or are you currently on dialysis? |
| | Yes No |
| CQ21 | How many months did you take at least 4 medications? (a) =0 (b) 1 (c) 2-6 |
| | (d) >=7 |
| CQ22 | How many times in the past year did you visit the emergency room? (a) =0 (b) |
| | 1 (c) 2-3 (d) >=4 |
| CQ23 | Have you been diagnosed with Alzheimer's disease? Yes No |
| CQ24 | Have you had temporary numbness or tingling, paralysis, or vision problems, or |
| | been diagnosed with a TIA (transient ischemic attack) or mini stroke? Yes No |
| CQ25 | Have you been treated for a heart attack in the past 12 months? Yes |
| CQ26 | When was your most recent visit to a physician? (a) currently (b) 1 mon. (c) 2 |
| | mon. (d) >=3 mon. |
| CQ27 | Did you deliver a baby/babies within the past 12 months? - another option might |
| | be - Did you complete or terminate a pregnancy within the past 12 months? |
| CQ28 | NULL |
| CQ29 | How many times did you have any type of outpatient surgery? (a) =0 (b) 1 (c) |
| | 2-3 (d) >=4 |
| CQ30 | Have the number of prescription medications you are taking increased over the past |
| | year? Yes No |

TABLE 10
Branching logic details.

| Leaf# | Branching Logic |
|---|---|
| Leaf1 | CQ1 = 10 |
| Leaf2 | CQ1 ˜= 10 & CQ2 = No & CQ3 = No & CQ4 = a |
| Leaf3 | CQ1 ˜= 10 & CQ2 = No & CQ3 = No & CQ4 = b |
| Leaf4 | CQ1 ˜= 10 & CQ2 = No & CQ3 = No & CQ4 = c |
| Leaf5 | CQ1 ˜= 10 & CQ2 = No & CQ3 = No & CQ4 = d |
| Leaf6 | CQ1 ˜= 10 & (CQ2 = Yes \| CQ3 = Yes) & CQ5 = b |
| Leaf7 | CQ1 ˜= 10 & CQ3 = Yes & CQ5 = a |
| Leaf8 | CQ1 ˜= 10 & CQ2 = Yes & CQ3 = No & CQ5 = a & CQ6 = b |
| Leaf9 | CQ1 ˜= 10 & CQ2 = Yes & CQ3 = No & CQ5 = a & CQ6 = c |
| Leaf10 | CQ1 ˜= 10 & CQ2 = Yes & CQ3 = No & CQ5 = a & CQ6 = d |

In the calculations listed in Table 11-20: Yes=1, No=0, (a)=0, (b)1, (c)=2, (d)=3. Age is an integer.

TABLE 11
Details in Leaf 1.

| | | |
|---|---|---|
| V1 | CQ10 | Age (derived from DQ2) |

Y = v1 × (0.037) + (3.5999)

TABLE 12
Details in Leaf 2.

| | | |
|---|---|---|
| V1 | CQ7 | How many medications did you take for longer than 6 months? |
| | | (a) =0 (b) 1-6 (c) 7-11 (d) >=12 |
| V2 | CQ8 | How many medications did you take? |
| | | (a) <=3 (b) 4-8 (c) 9-15 (d) >=16 |
| V3 | CQ9 | How many months did you not receive any medical treatment? |
| | | (a) <=3 (b) 4-7 (c) 8-10 (d) >=11 |
| V4 | CQ10 | Age (derived from DQ2) |
| V5 | CQ11 | How many medications did you take longer than 3 months? |
| | | (a) =0 (b) 1-2 (c) 3-9 (d) >=10 |
| V6 | CQ12 | Are you currently pregnant? |
| | | Yes No |
| V7 | CQ13 | How many times did you receive care at any of the following: freestanding |
| | | medical facility, outpatient hospital facility, or “other” healthcare provider: |
| | | (excludes physician office visits, hospital emergency room and outpatient |
| | | surgery). Examples: Freestanding Radiology (x-rays), Freestanding |
| | | laboratory, dialysis clinic, physical therapy. Other healthcare provider |
| | | examples: Chiropractor, acupuncturist, massage therapist, home health, |
| | | hospice, durable medical equipment such as wheelchair, oxygen |
| | | (a) =0 (b) 1 (c) 2-11 (d) >=12 |

Y = v1 × (1.765) + v2 × (1.435) + v3 × (−1.276) + v4 × (0.052) + v5 × (0.687) + v6 × (4.152) + v7 × (0.596) + (6.915)

TABLE 13
Details in Leaf 3.

| | | |
|---|---|---|
| V1 | CQ11 | How many medications did you take longer than 3 months? |
| | | (a) =0 (b) 1-2 (c) 3-9 (d) >=10 |
| V2 | CQ14 | How many months in the past year did you receive care at any of the |
| | | following: freestanding medical facility, outpatient hospital facility, or |
| | | “other” healthcare provider: (excludes physician office visits, hospital |
| | | emergency room and outpatient surgery). Examples: Freestanding |
| | | Radiology (x-rays), Freestanding laboratory, dialysis clinic, physical |
| | | therapy. Other healthcare provider examples: Chiropractor, acupuncturist, |
| | | massage therapist, home health, hospice, durable medical equipment such as |
| | | wheelchair, oxygen |
| | | (a) =0 (b) 1 (c) 2-6 (d) >=7 |
| V3 | CQ10 | Age (derived from DQ2) |
| V4 | CQ12 | Are you currently pregnant? |
| | | Yes No |
| V5 | CQ15 | When was the last time you received any medical care? |
| | | (a) currently (b) 1 mon. ago (c) 2-10 mon. ago (d) 11-12 mon. ago |
| V6 | CQ7 | How many medications did you take for longer than 6 months? |
| | | (a) =0 (b) 1-6 (c) 7-11 (d) >=12 |
| V7 | CQ8 | How many medications did you take? |
| | | (a) <=3 (b) 4-8 (c) 9-15 (d) >=16 |

Y = v1x(0.673) + v2x(0.851) + v3x(0.058) + v4x(9.373) + v5x(−0.765) + v6x(1.678) + v7x(0.955) + (5.543)

TABLE 14
Details in Leaf 4.

| | | |
|---|---|---|
| V1 | CQ7 | How many medications did you take for longer than 6 months? |
| | | (a) =0 (b) 1-6 (c) 7-11 (d) >=12 |
| V2 | CQ14 | How many months in the past year did you receive care at any of the |
| | | following: freestanding medical facility, outpatient hospital facility, or |
| | | “other” healthcare provider: (excludes physician office visits, hospital |
| | | emergency room and outpatient surgery). Examples: Freestanding |
| | | Radiology (x-rays), Freestanding laboratory, dialysis clinic, physical |
| | | therapy. Other healthcare provider examples: Chiropractor, acupuncturist, |
| | | massage therapist, home health, hospice, durable medical equipment such as |
| | | wheelchair, oxygen |
| | | (a) =0 (b) 1 (c) 2-6 (d) >=7 |
| V3 | CQ10 | Age (derived from DQ2) |
| V4 | CQ12 | Are you currently pregnant? |
| | | Yes No |
| V5 | CQ15 | When was the last time you received any medical care? |
| | | (a) currently (b) 1 mon. ago (c) 2-10 mon. ago (d) 11-12 mon. ago |
| V6 | CQ8 | How many medications did you take? |
| | | (a) <=3 (b) 4-8 (c) 9-15 (d) >=16 |
| V7 | CQ9 | How many months did you not receive any medical treatment? |
| | | (a) <=3 (b) 4-7 (c) 8-10 (d) >=11 |

Y = v1x(2.029) + v2x(1.236) + v3x(0.069) + v4x(9.019) + v5x(−0.95) + v6x(1.006) + v7x(−1.106) + (8.301)

TABLE 15
Details in Leaf 5.

| | | |
|---|---|---|
| V1 | CQ14 | How many months in the past year did you receive care at any of the |
| | | following: freestanding medical facility, outpatient hospital facility, or |
| | | “other” healthcare provider: (excludes physician office visits, hospital |
| | | emergency room and outpatient surgery). Examples: Freestanding |
| | | Radiology (x-rays), Freestanding laboratory, dialysis clinic, physical |
| | | therapy. Other healthcare provider examples: Chiropractor, acupuncturist, |
| | | massage therapist, home health, hospice, durable medical equipment such |
| | | as wheelchair, oxygen |
| | | (a) =0 (b) 1 (c) 2-6 (d) >=7 |
| V2 | CQ7 | How many medications did you take for longer than 6 months? |
| | | (a) <=0 (b) 1-6 (c) 7-11 (d) >=12 |
| V3 | CQ16 | Have you been diagnosed or treated for cancer in the past 12 months? |
| | | Yes No |
| V4 | CQ12 | Are you currently pregnant? |
| | | Yes No |
| V5 | CQ5 | Do you have any of the following uncommon diseases (Please check all that |
| | | apply) - How many? |
| | | (a) =0 (b) ˜=0 |
| V6 | CQ17 | Did you experience recurring back, neck or joint pain? |
| | | Yes No |
| V7 | CQ18 | How many months did you visit your doctor more than 3 times? |
| | | (a) =0 (b) 1 (c) 2-3 (d) >=4 |

Y = v1x(2.832) + v2x(3.654) + v3x(4.442) + v4x(10.085) + v5x(5.789) + v6x(1.793) + v7x(1.139) + (6.428)

TABLE 16
Details in Leaf 6.

| | | |
|---|---|---|
| V1 | CQ13 | How many times did you receive care at any of the following: freestanding |
| | | medical facility, outpatient hospital facility, or “other” healthcare provider: |
| | | (excludes physician office visits, hospital emergency room and outpatient |
| | | surgery). Examples: Freestanding Radiology (x-rays), Freestanding |
| | | laboratory, dialysis clinic, physical therapy. Other healthcare provider |
| | | examples: Chiropractor, acupuncturist, massage therapist, home health, |
| | | hospice, durable medical equipment such as wheelchair, oxygen |
| | | (a) =0 (b) 1 (c) 2-11 (d) >=12 |
| V2 | CQ20 | Do you have End Stage renal disease (ESRD) or are you currently on |
| | | dialysis? |
| | | Yes No |
| V3 | CQ16 | Have you been diagnosed or treated for cancer in the past 12 months? |
| | | Yes No |
| V4 | CQ26 | When was your most recent visit to a physician? |
| | | (a) currently (b) 1 mon. (c) 2 mon. (d) >=3 mon. |
| V5 | CQ6 | How many days did you spend in the hospital or other inpatient facility? |
| | | (a) 0 (b) 1-3 (c) 4-11 (d) >=12 |
| V6 | CQ29 | How many times did you have any type of outpatient surgery? |
| | | (a) =0 (b) 1 (c) 2-3 (d) >=4 |
| V7 | CQ30 | Have the number of prescription medications you are taking increased over the |
| | | past year? |
| | | Yes No |
| V8 | CQ18 | How many months did you visit your doctor more than 3 times? |
| | | (a) =0 (b) 1 (c) 2-3 (d) >=4 |

Y = v1x(4.223) + v2x(15.161) + v3x(22.699) + v4x(−3.088) + v5x(3.58) + v6x(7.071) + v7x(7.44) + v8x(3.865) + (4.707)

TABLE 17
Details in Leaf 7.

| | | |
|---|---|---|
| V1 | CQ29 | How many times did you have any type of outpatient surgery? |
| | | (a) =0 (b) 1 (c) 2-3 (d) >=4 |
| V2 | CQ7 | How many medications did you take for longer than 6 months? |
| | | (a) =0 (b) 1-6 (c) 7-11 (d) >=12 |
| V3 | CQ14 | How many months in the past year did you receive care at any of the |
| | | following: freestanding medical facility, outpatient hospital facility, or |
| | | “other” healthcare provider: (excludes physician office visits, hospital |
| | | emergency room and outpatient surgery). Examples: Freestanding |
| | | Radiology (x-rays), Freestanding laboratory, dialysis clinic, physical |
| | | therapy. Other healthcare provider examples: Chiropractor, acupuncturist, |
| | | message therapist, home health, hospice, durable medical equipment such as |
| | | wheelchair, oxygen |
| | | (a) =0 (b) 1 (c) 2-6 (d) >=7 |
| V4 | CQ26 | When was your most recent visit to a physician? |
| | | (a) currently (b) 1 mon. (c) 2 mon. (d) >=3 mon. |
| V5 | CQ6 | How many days did you spend in the hospital or other inpatient facility? |
| | | (a) 0 (b) 1-3 (c) 4-11 (d) >=12 |
| V6 | CQ18 | How many months did you visit your doctor more than 3 times? |
| | | (a) =0 (b) 1 (c) 2-3 (d) >=4 |
| V7 | CQ20 | Do you have End Stage renal disease (ESRD) or are you currently on |
| | | dialysis? |
| | | Yes No |
| V8 | CQ16 | Have you been diagnosed or treated for cancer in the past 12 months? |
| | | Yes No |

Y = v1x(3.2) + v2x(3.889) + v3x(2.154) + v4x(−1.746) + v5x(4.663) + v6x(1.941) + v7x(20.839) + v8x(6.905) + (6.115)

TABLE 18
Details in Leaf 8.

| | | |
|---|---|---|
| V1 | CQ21 | How many months did you take at least 4 medications? |
| | | (a) =0 (b) 1 (c) 2-6 (d) >=7 |
| V2 | CQ15 | When was the last time you received any medical care? |
| | | (a) currently (b) 1 mon. ago (c) 2-10 mon. ago (d) 11-12 |
| | | mon. ago |
| V3 | CQ10 | Age (derived from DQ2) |
| V4 | CQ22 | How many times in the past year did you visit the |
| | | emergency room? |
| | | (a) =0 (b) 1 (c) 2-3 (d) >=4 |
| V5 | CQ7 | How many medications did you take for longer than 6 |
| | | months? |
| | | (a) =0 (b) 1-6 (c) 7-11 (d) >=12 |
| V6 | CQ16 | Have you been diagnosed or treated for cancer in the past 12 |
| | | months? |
| | | Yes No |

Y = v1x(1.124) + v2x(−2.133) + v3x(0.09) + v4x(1.936) + v5x(3.5) + v6x(4.062) + (8.555)

TABLE 19
Details in Leaf 9.

| | | |
|---|---|---|
| V1 | CQ15 | When was the last time you received any medical care? |
| | | (a) currently (b) 1 mon. ago (c) 2-10 mon. ago (d) 11-12 mon. ago |
| V2 | CQ7 | How many medications did you take for longer than 6 months? |
| | | (a) =0 (b) 1-6 (c) 7-11 (d) >=12 |
| V3 | CQ16 | Have you been diagnosed or treated for cancer in the past 12 months? |
| | | Yes No |
| V4 | CQ13 | How many times did you receive care at any of the following: freestanding |
| | | medical facility, outpatient hospital facility, or “other” healthcare provider: |
| | | (excludes physician office visits, hospital emergency room and outpatient |
| | | surgery). Examples: Freestanding Radiology (x-rays), Freestanding |
| | | laboratory, dialysis clinic, physical therapy. Other healthcare |
| | | provider examples: Chiropractor, acupuncturist, massage therapist, |
| | | home health, hospice, durable medical equipment such as wheelchair, oxygen |
| | | (a) =0 (b) 1-1 (c) 2-11 (d) >=12 |
| V5 | CQ27 | Did you deliver a baby/babies within the past 12 months? |
| | | Yes No |
| V6 | CQ18 | How many months did you visit your doctor more than 3 times? |
| | | (a) =0 (b) 1 (c) 2-3 (d) >=4 |
| V7 | CQ19 | How many times were you admitted to the hospital (inpatient stay)? |
| | | (a) =0 (b) 1 (c) 2-4 (d) >=5 |

Y = v1x(−2.817) + v2x(3.929) + v3x(10.091) + v4x(1.824) + v5x(−5.913) + v6x(1.798) + v7x(4.889) + (7.165)

TABLE 20
Details in Leaf 10.

| | | |
|---|---|---|
| V1 | CQ19 | How many times were you admitted to the hospital |
| | | (inpatient stay)? |
| | | (a) =0 (b) 1 (c) 2-4 (d) >=5 |
| V2 | CQ20 | Do you have End Stage renal disease (ESRD) or are you |
| | | currently on dialysis? |
| | | Yes No |
| V3 | CQ8 | How many medications did you take? |
| | | (a) <=3 (b) 4-8 (c) 9-15 (d) >=16 |
| V4 | CQ22 | How many times in the past year did you visit the emergency |
| | | room? |
| | | (a) =0 (1) 1 (c) 2-3 (d) >=4 |
| V5 | CQ23 | Have you been diagnosed with Alzheimer's disease? |
| | | Yes No |
| V6 | CQ24 | Have you had temporary numbness or tingling, paralysis, |
| | | or vision Problems, or been diagnosed with a TIA (transient |
| | | ischemic attack) or mini stroke? |
| | | Yes No |
| V7 | CQ25 | Have you been treated for a heart attack in the past |
| | | 12 months? |
| | | Yes No |

Y = v1x(7.543) + v2x(22.28) + v3x(4.009) + v4x(2.462) + v5x(43.457) + v6x(29.742) + v7x(−13.886) + (9.23)

TABLE 21
Guidance for the scores.

| | | | | Need |
|---|---|---|---|---|
| | Excellent | Good | Improve | Help |
| Score A | >=8.2 | <8.2 and >=7 | <7 and >=5.9 | <5.9 |
| Score B (Age 0-20) | >=8.4 | <8.4 and >=7.3 | <7.3 and >=6.3 | <6.3 |
| Score B | >=8.0 | <8.0 and >=7.0 | <7.0 and >=5.9 | <5.9 |
| (Age 21-44) | | | | |
| Score B | >=7.6 | <7.6 and >=6.6 | <6.6 and >=5.6 | <5.6 |
| (Age 45-64) | | | | |
| Score B (Age >=65) | >=7.2 | <7.2 and >=6.2 | <6.2 and >=5.2 | <5.2 |

—Some Technical Details for Modeling, Scoring, and Simulations.

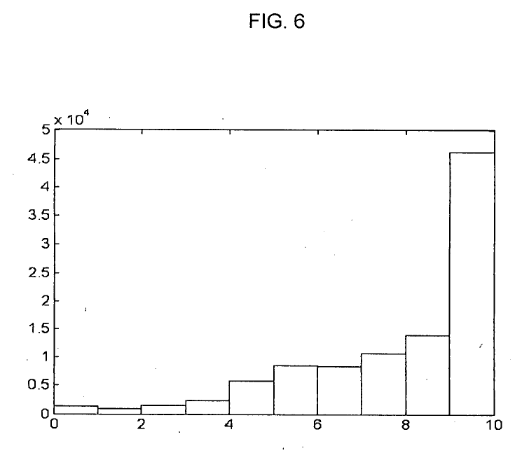

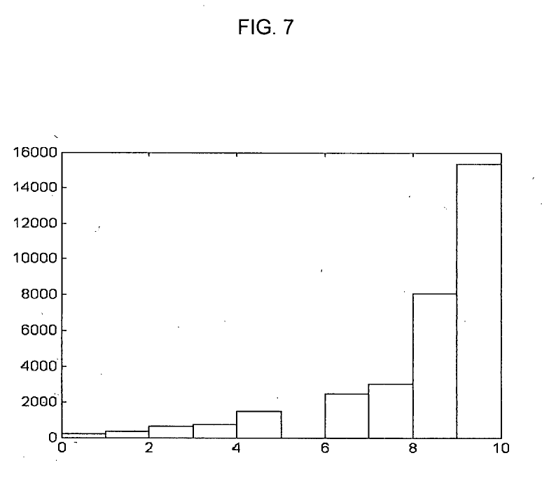

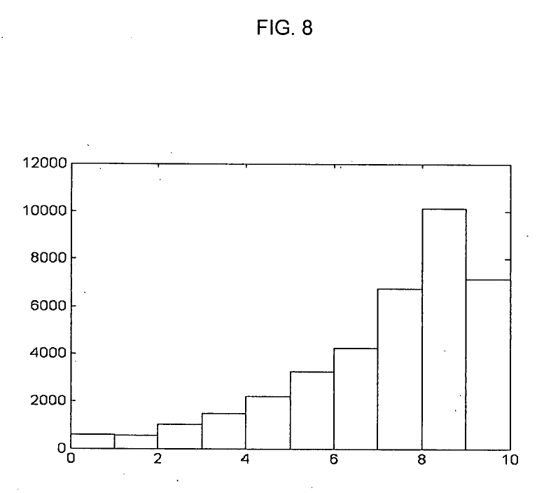

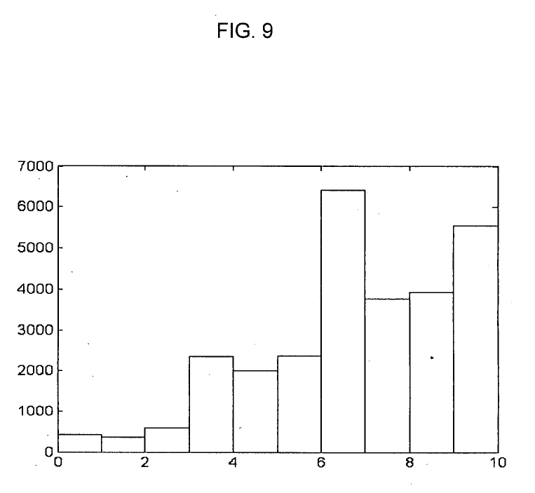

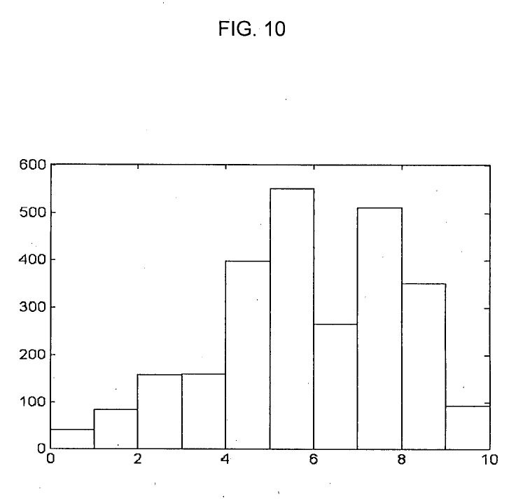

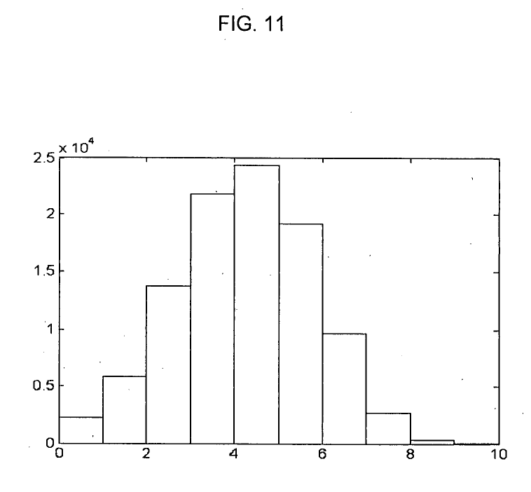

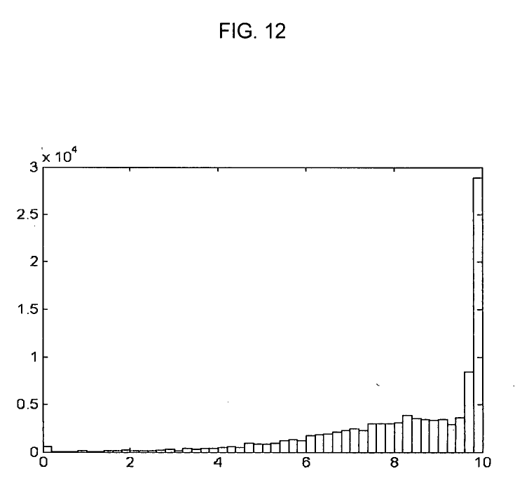

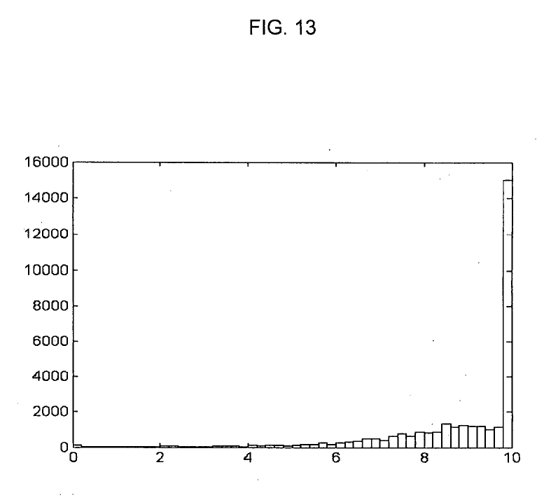

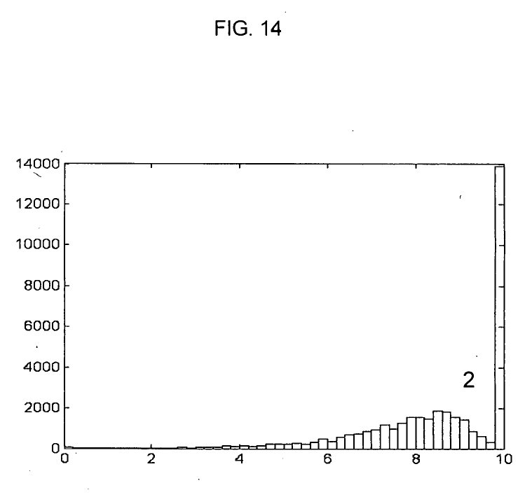

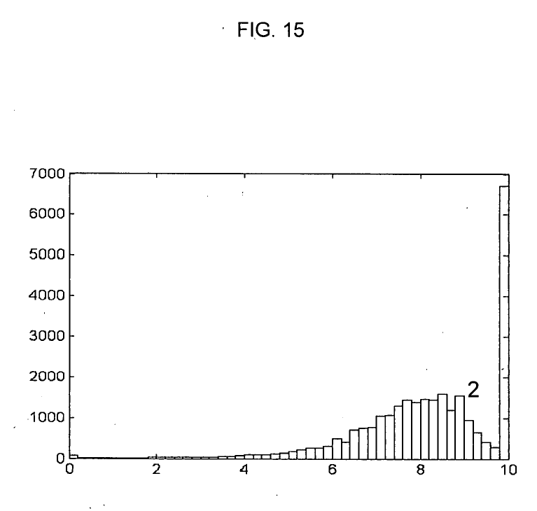

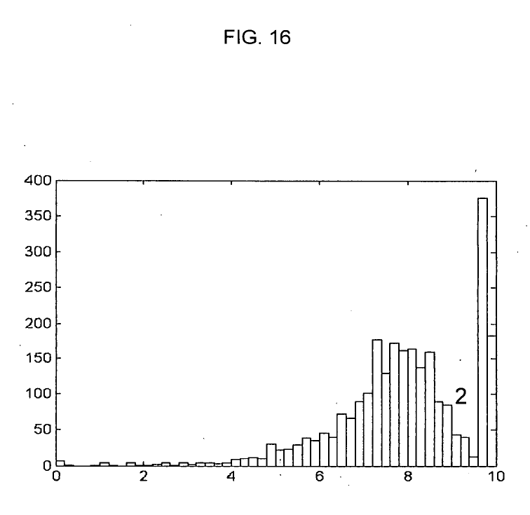

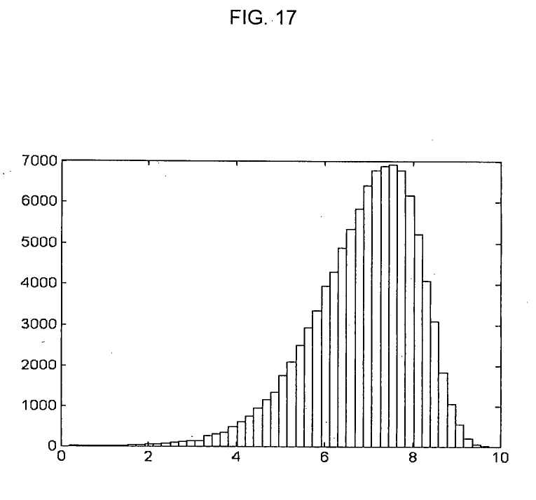

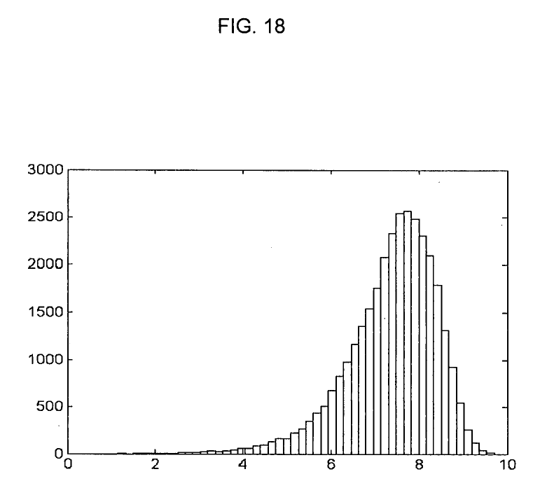

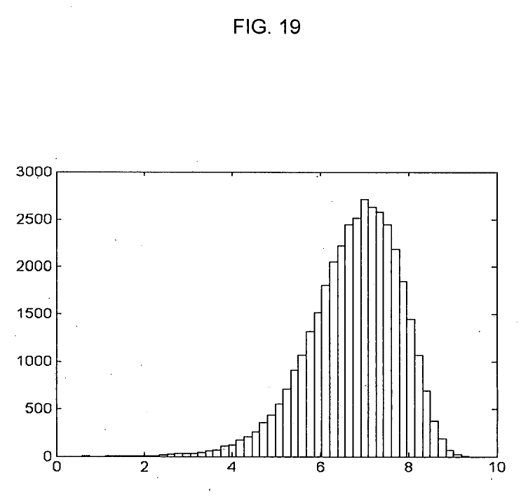

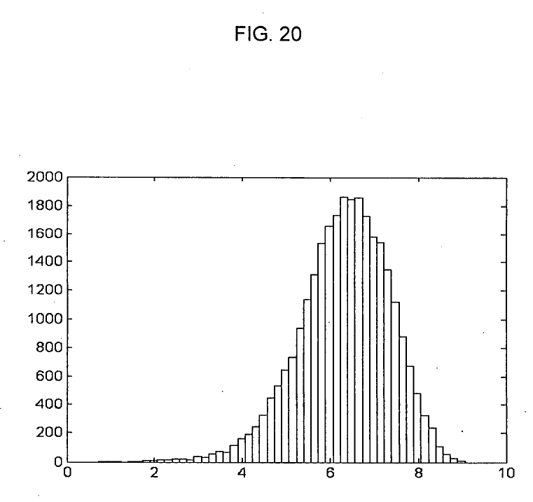

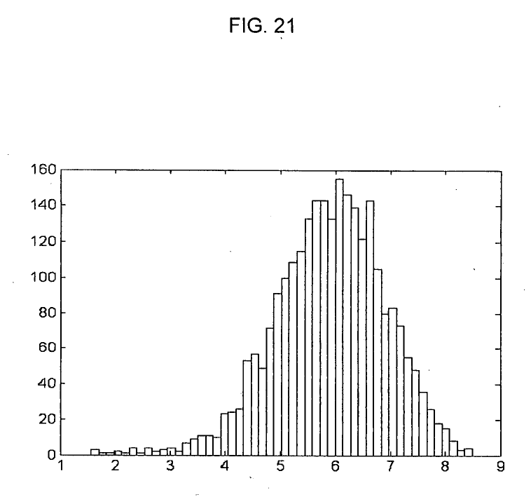

A. Computer simulation model—We built an extendable computer simulation model to test our scoring formulations and score distributions. Our model is based on the evidence from one or more of the three: 1. Claims data of Humana commercial population. 2. Healthcare literatures. 3. Domain knowledge from clinical expert. The score distributions are shown in FIGS. 6-21.

Why do we need the simulation model? The simulation model can help us on the following perspectives before we accumulate enough HRA data. 1. Simulate the score distribution which is necessary for the user to compare his health status with both the overall population and peers. 2. Obtain the optimum bound for truncation. 3. Check the validity of the whole scoring system and each of its components.

How do we simulate the score? Our simulation model is based on random number generator and meaningful distributions are imposed to govern the process. We simulate HRA scores of a large population of users (100K for the results demonstrated). The age is directly loaded from claims data. The key challenge is how to model the joint distribution of risk factors—there are so many of them falling in different categories. We assume that these factors are independent in general, and model some correlations in particular if strong evidences exist. The correlated factors currently modeled are: 1. Obesity—3 times more likely to develop diabetes. 2. Obesity—5 times more likely to have heart disease. 3. High cholesterol—3 times more likely to develop heart disease and stroke. 4. Diabetics—4 times more likely to develop heart disease and stroke.

Since chronic conditions monotonically progress with age, they are simulated according to the disease prevalence rate, which were extracted from 1.8 million Humana commercial members as a function of age and disease conditions. The rule of thumb in the simulation is we try to incorporate the existing evidence as much as possible while not to overload the model with unnecessary complexity. We are interested in the development of a causal network with multiple health risk factors (based on Bayes Net for example).

B. Quantization of Clinical Information.

Based on internal feedback and some popular health risk assessment websites like yourdiseaserisk.harvard.edu, it seems that a multiple choice format, choosing from several items like (a), (b), (c), (d), has better user acceptability than inputting a number. Therefore, we try to quantize the clinical information for HRA PM. At the first glance, the predicting performance could suffer from the quantization error. However, if we do it intelligently, the performance drop can be minimized and indeed it is very acceptable.

The key idea of our quantization method is based on Classification and Decision Tree (CART). First use CART to build a full tree with just one feature subject to quantization. It is a supervised method so we need the model output (here square root PMPM). Then prune the tree to find appropriate number of nodes (number of quantization intervals, here is 4). Finally we obtain the cut points for quantization.

The essence of CART based quantization is to minimize the sum of square error between the true outputs and predicted ones, where the latter is simply the average in the cut region. Since in HRA PM the predicting power of each individual feature is not high—means not much information existed, then a well designed cut won't sacrifice it substantially. In fact, we find the performance drop is negligible in our results.

C. Normalization. We didn't normalize the score by using the highest possible value associated with all risk factors; rather we derived the coefficients for normalization from the score distribution, which is obtained with our simulation model. Since the probability of individual user meets all (or majority of) factors is really low, by normalizing this way, the score is better balanced. If one user meets quite some factors in the scoring table, the score could be. negative without bound. However, it is not likely and the score will be bounded anyway.

By reference to the instant application, the person skilled in the art to which the instant invention pertains is able to practice the following method and to construct a system for the implementation thereof. A method for assessing individual healthfulness and for providing health-enhancing behavioral advice and promoting adherence thereto, the method comprising the steps of:

a. providing to an individual an initial set of one or more questions concerning the individual's healthfulness;

b. receiving the individual's response to the initial set of one or more questions;

c. partitioning the set of possible responses to the initial set of one or more questions into a multiplicity of mutually exclusive groups;

d. assigning the individual's response to the initial set of one or more questions to one of the multiplicity of mutually exclusive groups;

e. providing to the individual one or more second-tier health-related questions, the one or more second-tier questions tailored to the healthfulness of a typical member of the one of the multiplicity of mutually exclusive groups;

f. receiving the individual's response to the one or more second-tier questions;

g. partitioning the set of possible responses to the one or more second-tier questions into a further multiplicity of mutually exclusive groups;

h. assigning the individual's response to the one or more second-tier questions to one of the further multiplicity of mutually exclusive groups;

i. providing to the individual one or more behavior-related questions, the one or more behavior-related questions tailored to one or more health-related behavioral needs of a typical member of the one of the further multiplicity of mutually exclusive groups to which the individual's response to the one or more behavior-related questions has been assigned;

j. receiving the individual's response to the one or more behavior-related questions;

k. partitioning the set of possible responses to the one or more behavior-related questions into a final multiplicity of mutually exclusive groups;

l. assigning the individual's response to the one or more behavior-related questions to one of the final multiplicity of mutually exclusive groups;

m. and providing to the individual behavioral advice, the behavioral advice tailored both to one or more health-related behavioral needs of a typical member of the one of the further multiplicity of mutually exclusive groups and also to one or more behavioral proclivities of a typical member of the one of the final multiplicity of mutually exclusive groups;

n. wherein the providing of the behavioral advice optionally comprises displaying in a display visible to the individual one or more graphical or textual descriptors of one or more aspects of the individual's healthfulness in comparison to the same one or more aspects of others' healthfulness, one or more graphical or textual plaudits concerning one or more salutary aspects of the individual's healthfulness, and one or more graphical or textual cues concerning one or more healthfulness-related behaviors tailored both to one or more health-related behavioral needs of a typical member of the one of the further multiplicity of mutually exclusive groups and also to one or more behavioral proclivities of a typical member of the one of the final multiplicity of mutually exclusive groups.

The foregoing detailed description is given primarily for clearness of understanding and no unnecessary limitations are to be understood therefrom for modifications can be made by those skilled in the art upon reading this disclosure and may be made without departing from the spirit of the invention and scope of the appended claims.

What is claimed is:

1. A system for assessing individual healthfulness and for providing health-enhancing advice, comprising:
a. at least one user computer which provides user access to a server system; said server system including a question database containing a plurality of health risk assessment questions, a feedback database containing content for each of a plurality of user groups, and a processor,
b. where said server system communicates with a user using one of said at least one user computers to access said server system; said server system presenting at least one of said health risk assessment questions to said user and then presenting additional questions to said user, said additional questions presented dependant on how said user answered previous questions; said server system placing said user into one of said plurality of user groups, said placement dependant upon how said user answered said questions presented to said user; and where said server system provides health-enhancing feedback advice to said user, which advice is determined by the user group said user has been placed into.

2. The system of claim 1, where said user access to said server system is facilitated by a communications link.

3. The system of claim 1, where said user access to said server system is accomplished over the Internet.

4. The system of claim 1, where said plurality of health risk assessment questions are divided into sets of questions which are hierarchically linked based on different user responses.

5. The system of claim 1, where said health risk assessment questions include questions pertaining to a user's healthfulness, questions pertaining to a user's behavior, and questions pertaining to a user's lifestyle.

6. The system of claim 1, where said health-enhancing feedback advice to said user includes information on at least one of future health status, likely disease progression, comparison of said user to a group of said user's peers, encouraging information, behavioral modification suggestions, and places where additional information can be found.

7. The system of claim 1, where said health-enhancing feedback advice to said user includes a health risk assessment score calculated by said server system based on said user's answers to said questions presented.

8. The system of claim 7, where said health risk assessment score is calculated using a formula which is validated using claims data and computer simulations with derived prevalence rates.

9. The system of claim 7, where said health-risk enhancing feedback advice to said user includes a peer health risk assessment score to demonstrate to said user how said user's health risk assessment score compares to said user's peers' score.

10. The system of claim 7, where said user's health risk assessment score is a weighted combination of a disease history score, a behavioral/lifestyle/family history score, and a clinical score.

11. A method for assessing individual healthfulness and for providing health-enhancing behavioral advice, comprising the steps of:
a. having a user access a web site using a secure logon;
b. presenting to said user a question set having at least one question therein;
c. receiving said user's response to said question set;
d. dependant upon said user's response to said question set, repeating steps b and c until said user can be placed into one of a plurality of mutually exclusive user groups;
e. optionally presenting to said user additional question sets dependant on said user's user group placement;
f. receiving said user's response to any questions presented to said user in step e; and,
g. providing health-enhancing feedback advice to said user, which advice is determined by said user's user group and said user's responses in step f.

12. The method of claim 11, where each said question set comprises at least one health risk assessment question, said question sets being hierarchically linked based on different user responses.

13. The method of claim 12, where said health risk assessment questions include questions pertaining to a user's healthfulness, questions pertaining to a user's behavior, and questions pertaining to a user's lifestyle.

14. The method of claim 11, where said health-enhancing feedback advice to said user includes information on at least one of future health status, likely disease progression, comparison of said user to a group of said user's peers, encouraging information, behavioral modification suggestions, and places where additional information can be found.

15. The method of claim 11, where said health-enhancing feedback advice to said user includes a health risk assessment score based on said user's answers to said questions presented.

16. The method of claim 15, where said health risk assessment score is calculated using a formula which is validated using claims data and computer simulations with derived prevalence rates.

17. The method of claim 15, where said health-risk enhancing feedback advice to said user includes a peer health risk assessment score to compare how said user's health risk assessment score relates to said user's peer score.

18. The method of claim 15, where said user's health risk assessment score is a weighted combination of a disease history score for said user, a behavioral/lifestyle/family history score for said user, and a clinical score for said user.

19. A method for assessing individual healthfulness and for providing health-enhancing behavioral advice, comprising the steps of:
a. providing to an individual an initial set of one or more questions concerning the individual's healthfulness;
b. receiving the individual's response to the initial set of one or more questions;
c. partitioning the set of possible responses to the initial set of one or more questions into a multiplicity of mutually exclusive groups;
d. assigning the individual's response to the initial set of one or more questions to one of the multiplicity of mutually exclusive groups;
e. providing to the individual one or more second-tier health-related questions, said one or more second-tier questions tailored to the healthfulness of a typical member of said one of the multiplicity of mutually exclusive groups;
f. receiving the individual's response to the one or more second-tier questions;
g. partitioning the set of possible responses to the one or more second-tier questions into a further multiplicity of mutually exclusive groups;
h. assigning the individual's response to the one or more second-tier questions to one of the further multiplicity of mutually exclusive groups;
i. providing to the individual one or more behavior-related questions, said one or more behavior-related questions tailored to one or more health-related behavioral needs of a typical member of said one of the further multiplicity of mutually exclusive groups to which the individual's response to the one or more behavior-related questions has been assigned;
j. receiving the individual's response to the one or more behavior-related questions;
k. partitioning the set of possible responses to the one or more behavior-related questions into a final multiplicity of mutually exclusive groups;
l. assigning the individual's response to the one or more behavior-related questions to one of the final multiplicity of mutually exclusive groups; and,
m. and providing to the individual behavioral advice based on the final multiplicity of mutually exclusive groups containing the individual.

20. The method of claim 19, where the behavioral advice provided to the individual is tailored both to one or more health-related behavioral needs of a typical member of said one of the further multiplicity of mutually exclusive groups and also to one or more behavioral proclivities of a typical member of said one of the final multiplicity of mutually exclusive groups.

21. The method of claim 19 where the behavioral advice provided to the individual comprises displaying in a display visible to the individual at least one descriptor of at least one aspect of the individual's healthfulness in comparison to the same at least one aspect of others' healthfulness, at least one plaudit concerning at least one salutary aspect of the individual's healthfulness, and at least one cue concerning at least one healthfulness-related behavior tailored both to at least one health-related behavioral need of a typical member of said one of the further multiplicity of mutually exclusive groups and also to at least one behavioral proclivity of a typical member of said one of the final multiplicity of mutually exclusive groups.

22. The method of claim 19, where the behavioral advice provided to the individual includes a health risk assessment score based on said individual's responses to said questions presented.

23. The method of claim 22, where said health risk assessment score is calculated using a formula which is validated using claims data and computer simulations with derived prevalence rates.
